(19) United States
(12) Patent Application Publication
(10) Pub. No.: US 2016/0252541 A1
(43) Pub. Date: Sep. 1, 2016

(54) Method of bridging quantum and classical physics

(71) Applicant: James D. Welch, Omaha, NE (US)

(72) Inventor: James D. Welch, Omaha, NE (US)

(21) Appl. No.: 14/999,399

(22) Filed: May 3, 2016

(51) Int. Cl. G01N 37/00; G21K 1/00; G01B 9/02

(52) U.S. Cl. CPC G01N 37/005; G01B 9/02; G21K 1/00; G01B 2290/55

(57) ABSTRACT

A method for analyzing the results of a Double Slit experiment in a way that allows forming a bridge between Quantum and Classical Physics.

### TECHNICAL FIELD

The present invention relates to the Double Slit experiment, and more particularly to a method for analyzing the results thereof in a way that allows forming a bridge between Quantum and Classical Physics.

### BACKGROUND

The importance of the Double Slit System in Quantum Physics is well known. In fact, none less that Nobel Prize winner Richard Fynman stated that the experiment associated with the Double Slit System, in which an Interference Pattern is formed on A screen positioned after a barrier containing two closely spaced slits, when particles or photons are directed at said Slits, comprises all the mysteries of Quantum Mechanics. Quantum Physics treats the results of the Double Slit experiment as proof that the Quantum Uncertainty Principle is valid as a particle or photon passing through one, (or both as some Quantum Physicists argue), slit(s) in said double slit containing barrier is relatively well positioned at the time of passing therethrough, and therefore the momentum of said particle or photon cannot be known with any better certainty than given by dividing Plank's Constant by the uncertainty in said positioning. That is:

Δx×Δp=h/2

where ̂x is uncertainty in position of the particle or photon, and ̂p is uncertainty in momentum thereof. This is accepted as proof that is not to be challenged, as to why one can never know where on a screen upon which an Interference Pattern appears a specific particle or photon impacts. The only thing that can be known is that there is a higher probability a particle or photon will land in some locations than in others, and this explains the wave-like results of peaks and troughs forming. Said peaks and troughs are associated with positive and negative phase addition, respectively.

Physicists such as Bohm, and earlier DeBroglie have proposed that a “Piolet Wave” guides particles and photons on their journey through a Double Slit arrangement, to their point of impact with a Screen on which an Interference Pattern forms. However, such approaches have not been successful.

All in the area seem to subscribe to the concept of a dual nature of particles and waves, which the Inventor finds reasonable, but all accepted authority seems to cling tightly to the idea that Quantum Uncertainty is a bit of a sacred cow. It is simply not to be questioned. This is not unexpected in that, to date, all those who have been so bold as to question Quantum Uncertainty have routinely been proven to be wrong in their approach.

Continuing, the inventor herein has never found the Quantum Uncertainty Principle satisfying, and believes that it is the result of Chaos effects that occur at the Slits. In fact, in pursuit of an approach to show that Quantum Uncertainty is not the absolute it is held out to be, the Inventor/Applicant herein has filed numerous Applications, which have published as: 2014/0084178; 2011/0291006; 2011/0235044; 2011/0116096; 2010/0309481; 2010/0243917. The Inventor has found the Scientific and Patent Communities, not surprisingly, very unreceptive to his ideas and efforts in this area, but he is not yet willing to join the ranks of those who proposed a Piolet Wave, and failed to arrive at an approach that worked. In that light, the Inventor is back again, herein, with the proposal that Classical Physics and Chaos effects at the Slits can be applied to account for the results of the Double Slit experiment, by a Classically based approach to mathematically modeling the Double Slit experiment.

### DISCLOSURE OF THE INVENTION

The present invention is a method of analyzing results provided by a Double Slit System that can be considered to bridge Quantum mechanics with Classical Physics. The method accepts a “dual” nature of particles/photons and wave, but sees no reason that a wave cannot be considered to simply accompany any moving particle or photon. Simply put—if a particle or photon is moving it is accompanied by a wave. This is a form of dual wave/particle properties which is based on a concept of inseperability which holds that a moving photon or particle necessarily has an inseperable wave associated therewith, rather that the concept of complete conversion of one to the other depending on conditions in which it is found. If the wave is canceled by negative phase addition, a particle or photon necessarily stops propagating, and if a positive phase addition occurs a moving photon or particle continues to propagate. In this basic concept the Inventor proposes an approach to showing that the chasm between Quantum and Classical Physics can be bridged. It is noted that the concept of an “Interference Field”, which the Inventor herein has not seen described before as such, is focal in the proposed methodology disclosed directly. Said Interference Field provides regions of positive and regions of negative phase addition between the Slits and the Screen on which the Interference Pattern forms.

The present invention method begins with:
a) providing a double slit system sequentially comprising:
   a source of particles or photons;
   a barrier comprising two slits;
   an interference pattern display screen;

such that in use a particle or photon is provided by said source of particles or photons and is directed toward said barrier comprising two slits, with which barrier comprising two slits said particle or photons or photons interact in a manner that results in an interference pattern forming on the interference pattern display screen.

The method continues with:
b) one by one considering that a sequence of single particles or photons are provided by said source thereof and are caused to interact with said barrier comprising two slits, to the end that an interference pattern is developed on said interference pattern display screen;
c) effectively modeling said double slit system as two single slit systems and each said particle or photon as in functional combination with an inseperable wave; and considering that each said particle or photon passes through one of said slits, and such that said wave which is in functional combination therewith passes through both said slits and forms an interference field between said barrier comprising two slits and said interference pattern display screen;
d) considering that each said particle or photon is refracted as it passes through said single slit, and is directed into said interference field along a trajectory that is dependent on how the particle or photon was refracted, (which in turn is dependent on where within the width of the slit it passes);
e) considering that if each said particle or photon is directed by said refraction along a path of positive phase addition in the interference field that is will propagate and contribute to formation of a peak in a developing interference pattern on said interference pattern display screen; but that if said particle or photon is refracted so as to follow along a path of negative phase addition said particle or photon ceases to propagate and thereby does not contribute to formation of a developing interference pattern on said interference pattern display screen, but rather its lack of propagation is responsible for the existence of a trough therein.

It is believed that said approach bridges Quantum and Classical Physics by providing a model based in Classical Physics and Chaos Theory that predicts the results achieved by practice of the Double Slit experiment. The predictions of the said Classically based modeling are consistent with what Quantum Uncertainty provides, but trace the entire result to Chaos effects at the Slits.

The major effects are:
chaos effects occur at the Slit through which a particle or photon passes, and where within the width of a slit the particle or photon passes determines how said particle or photon is refracted when passing through said slit and on what trajectory it is then sent along; and
an Interference Field is formed between the barrier containing two slits and the screen on which an Interference Pattern forms, and if a particle or photon is refracted so as to proceed along a pathway of positive phase addition in said Interference Field it will continue to propagate, but if it is refracted to proceed along a pathway of negative phase addition, it stops propagating.

Of coures, the present invention methodology can comprise conducting a typical quantum physics directed analysis of the results achieved in step b), and determining that the results achieved in steps d) and e) are consistent therewith.

The present invention will be better understood by reference to the Detailed Description of this Specification, with reference to the Drawings.

### BRIEF DESCRIPTION OF THE DRAWINGS

FIG. 1 shows a prior art Double Slit system for reference.

FIG. 2 shows insight as to the basis of the present invention.

### DETAILED DESCRIPTION

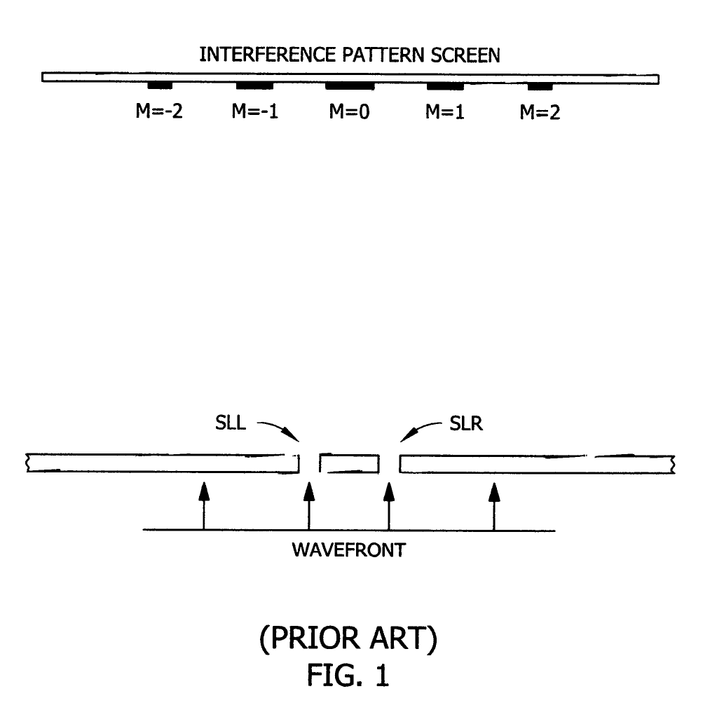

Turning now to FIG. 1, there is shown a very general representation of a Double Slit system. A wavefront approaches the Slits (SLR) and (SLL), passes through them and an Interference Pattern appears on a Screen placed some distance from the Slits. FIG. 1 is left generally vague because, as typically presented, Quantum theory holds that there is no way to know where within the Interference Pattern a specific photon or particle will contribute to the Interference Pattern, only that there are greater likelihoods that a photon or particle will contribute to a Peak region. The probabilities are the result of applying wave theory including positive and negative phase addition of wavelets which simultaneously exit the Slits (SLR) and (SLL).

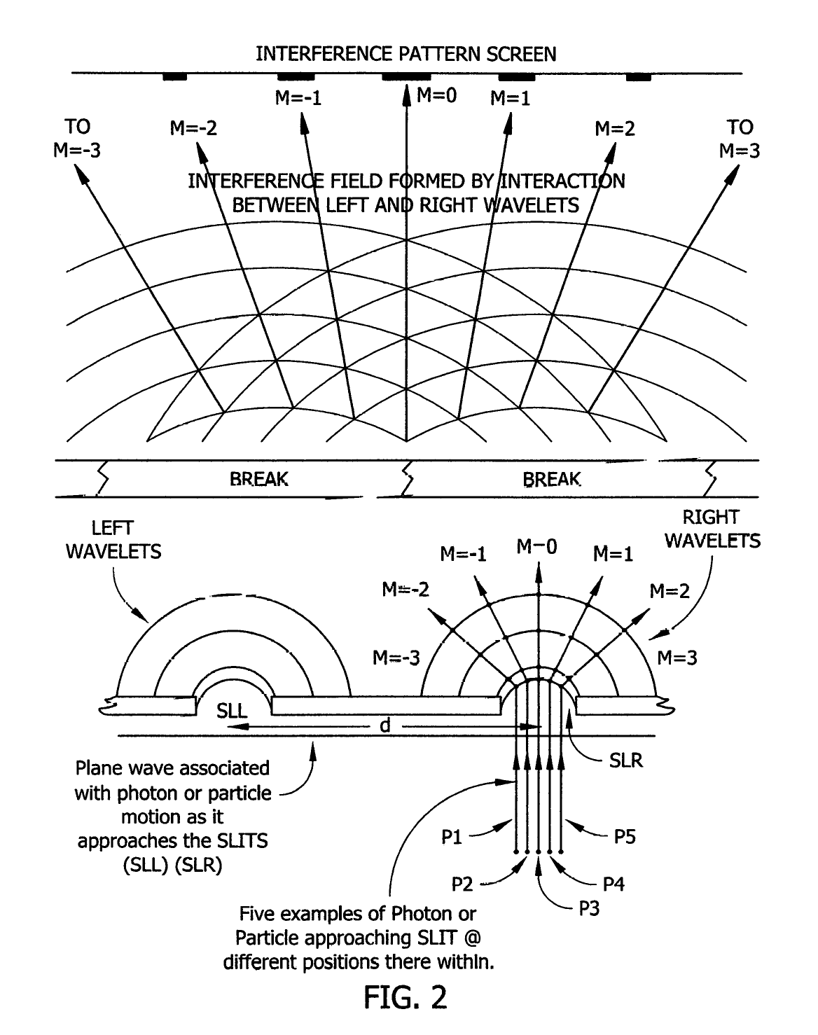

Turning now to FIG. 2, there is shown an expanded view of Left and Right Slits (SLL) and (SLR), and of a region near the Screen upon which an Interference Pattern forms in a conventional Double Slit System. Also shown are various approaching Particle Trajectories (P1) (P2) (P3) (P4) and (P5) at the Right Slit (SLR). As the wavelet at the right Slit (SLR) developes beyond it, note it directs the particle along a different refracted trajectory (M=0) (M=+/−1) (M=+/−3) depending on it's specific trajectory prior to the Slit (SLR) and where within the width of the Slit (SLR) it passed. A second wavelet also develops at the Left Slit (SLL). A page break is then indicated to show that a majority of the region between the Slits and the Interference Pattern Screen is absent in FIG. 2. The Page Break is followed by a scenario near the Interference Pattern Screen. An Interference Field is shown as formed by interaction between the wavelets form the Left and Right Slits. This field of course is present everywhere between the Slits and the Interference Pattern Screen. Note that if the particle is refracted to proceed along a path that presents to it Positive Phase addition, it continues to propagate, but if it is directed along a path of Negative Phase Addition, the Particle stops propagating. Note in FIG. 2 that the M=+/−1, +−2 etc. indicators at the Right Slit (SLR) are shown to indicate refraction of photons or particles in a direction along which positive phase addition occurs, and the same indicators M=+/−1, +−2 etc. at the Interference Pattern Screen are directly associated with those at the Right Slit (SLR). Again, the Left Slit (SLL) could just as well have been used.

The present invention provides that it is possible to model a Double Slit System so that given where within a Slit a photon or particle passes, it is refracted in a way that directs it to proceed along a specific trajectory. If that trajectory is along a pathway of positive phase addition in an Interference Field formed by the wavefront passing through both Slits (SLR) and (SLL), it will proceed and contribute to a Peak. If it is refracted to proceed along a pathway of negative phase addition, it will stop propagating and contribute to the formation of a trough in the Interference Pattern. Chaos effects at the Slit through which a photon or particle passes then, entirely determines how the photon or particle is refracted as it exits said Slit, and the Interference Field between the Slits and the Screen on which the Interference Pattern forms determines if the photon or particle continues or stops propagating.

To the Inventor's knowledge no one has previously suggested a combination of refraction of a photon or particle at a Slit, and interaction with an Interference Filed between the Slits and an Interference Pattern Screen can account for how an Interference Pattern is formed in a Double Slit system. This is a purely Classical approach, including Chaos effects at the Slit through which a photon or particle passes. Quantum theory still applies to arrive at it's very nebulous end result—which basically says it's all a mystery etc. But the present invention enables showing how that nebulous end result an be equated to Classical concepts. A “Bridge” between Classical and Quantum is then possible.

Having hereby disclosed the subject matter of the present invention, it should be obvious that many modifications, substitutions, and variations of the present invention are possible in view of the teachings. It is therefore to be understood that the invention may be practiced other than as specifically described, and should be limited in its breadth and scope only by the Claims.

1. A method of analyzing results provided by a Double Slit System that bridges quantum mechanics with classical physics comprising:
a) providing a double slit system sequentially comprising:
a source of particles or photons;
a barrier comprising two slits;
an interference pattern display screen;
such that in use a particle or photon is provided by said source of particles or photons and is directed toward said barrier comprising two slits, with which barrier comprising two slits said particle or photons or photons interact in a manner that results in an interference pattern forming on the interference pattern display screen;
b) one by one considering that a sequence of single particles nr photons are provided by said source thereof and are caused to interact with said barrier comprising two slits, to the end that an interference pattern is developed on said interference pattern display screen;
c) effectively modeling said double slit system as two single slit systems and each said particle or photon as in functional combination with an inseperable wave; and considering that each said particle or photon passes through one of said slits, and such that said wave which is in functional combination therewith passes through both said slits and forms an interference field between said barrier comprising two slits and said interference pattern display screen;
d) considering that each said particle or photon is refracted as it passes through said single slit, and is directed into said interference field along a trajectory that is dependent on how the particle or photon was refracted;
e) considering that if each said particle or photon is directed by said refraction along a path of positive phase addition in the interference field that is will propagate and contribute to formation of a peak in a developing interference pattern on said interference pattern display screen; but that if said particle or photon is refracted so as to follow along a path of negative phase addition said particle or photon ceases to propagate and thereby does not contribute to formation of a developing interference pattern on said interference pattern display screen, but rather its lack of propagation is responsible for the existence of a trough therein.

2. A method as in claim 1, which further comprises conducting a typical quantum physics directed analysis of the results achieved in step b) therein, and determining that the results achieved in steps d) and e) are consistent therewith.
